(19) United States
(12) Patent Application Publication
(10) Pub. No.: US 2008/0143100 A1
(43) Pub. Date: Jun. 19, 2008

(54) Connector and method

(75) Inventor: David Webster, Monmouthshire (GB)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(73) Assignee: Energy Equipment Corporation

(21) Appl. No.: 11/901,016

(22) Filed: Sep. 14, 2007

(30) Foreign Application Priority Data
Sep. 19, 2006 (GB) 0618401.4

(51) Int. Cl. F16L 35/00

(52) U.S. Cl. 285/18

(57) ABSTRACT

The invention provides a connector having a first part, a second part and a securing assembly associated with the second part. The first and second parts are selectively engagable. The first part is movable by a remotely actuable transporter and the securing assembly is provided for securing the connection between the first and second parts. The first part can be manufactured from a material with a high strength-to-weight ratio, such as a syntactic foam. The invention also provides a stab plate adapted for use subsea and manufactured from buoyant material. The weight of the stab plate in water is less than 25 kilograms.

### FIELD OF THE INVENTION

The present invention relates to a connector and a method of making a connection. In particular, the invention provides a connector and a method of making hydraulic and/or electric connections between subsea terminations, which are commonly required in the oil and gas industry.

### BACKGROUND ART

Subsea electric and hydraulic connections are often effected by a connector in two selectively engagable and releaseable parts typically using a plug/socket arrangement or interengaging pins. FIGS. 1a and 1b show examples of conventional connectors. FIG. 1b is a side view of a typical prior art connector and FIG. 1a is a rear view of the flying part of the FIG. 1b connector.

A permanent or semi-permanent subsea installation may have one or more connector parts (hereinafter a “fixed part” 40) attached to the structure 46 and the other part of the connector is typically a stab plate (hereinafter a “flying part” 20) that is connectable to the fixed part 40 using a remotely operated vehicle (ROV).

The flying part 20 includes a reinforced plate 26 having connecting pins 18 and an alignment pin 22 extending perpendicular to the plate 26. The reinforced plate 26 is coupled to a lead 10 via a termination clamp 12. The lead 10 carries a bundle of lines 14, such as electrical wires or hydraulic lines that are individually connected to the rear of each of the connecting pins 18. A drive means 16 is mounted on the rear face of the reinforced plate 26. The drive means 16 is operable by an ROV to rotate a threaded locking screw 24 that is thereby selectively engagable with the fixed part 40.

The fixed part 40 comprises a static subsea termination having a connector plate 44 with a threaded cylindrical locking hole (not shown) for receiving the locking screw 24. The connector plate 44 also has connecting pins 42 extending perpendicular therefrom for mating with the connecting pins 18 of the flying part 20.

When it is desired to make the connection between the flying part 20 and the fixed part 40, an ROV (not shown) engages the drive means 16 and transports the flying part 20 adjacent the connector plate 44. The ROV activates the drive means 16 to rotate the locking screw 24 and couple the fixed part 40 with the flying part 20 and secure the connecting pins 18, 42 into engagement with one another.

The flying part 20 must be constructed such that it is below a certain maximum weight depending on the lifting limitations of the ROV. As a result, it often becomes necessary to use several connectors to carry the required number of lines 14 in the lead 10 since a single separate flying part 20 may be too heavy for transportation by an ROV. To avoid this problem, the flying part 20 can be manufactured from a lightweight material such as nylon and titanium. However, this can significantly increase the build costs of the flying part 20. Alternatively, additional buoyancy can be coupled to the flying part 20 to reduce the effective weight, but the need to add the buoyancy prior to use can increase installation costs.

### SUMMARY OF THE INVENTION

According to a first aspect of the invention, there is provided a connector having a first part, a second part and a securing assembly associated with the second part, wherein the first and second parts are selectively engagable and wherein the first part is movable by a remotely actuable transporter; and wherein the securing assembly is provided for securing the connection between the first part and the second part.

According to the first aspect of the invention, there is provided a method for making a connection including the steps of providing a connector having a first part and a second part; associating a securing assembly with the second part; engaging the first and second parts to make a connection therebetween; and engaging the securing assembly with the first part to secure the first and second parts.

The connector can be a subsea connector. The method of the first aspect of the invention can be carried out subsea.

The first and second parts can each be provided with at least one complementary connection. For example, the connections can comprise a plug and a socket arrangement or interengaging pins.

The connector can be used to provide communication between at least one line when the first part is in engagement with the second part. Each of the first and second parts can carry at least one line. The at least one line carried by each of the first and second parts can be coupled to the at least one respective connection. The line(s) can comprise a hydraulic and/or an electric cable and/or a bundle of such cables.

The securing assembly is actuable between a securing configuration in which a secure connection is effected between the first and second parts and a non-securing configuration.

In the securing configuration the securing assembly can be arranged such that the separation force experienced when the first and second parts are in engagement is transferred to the securing assembly in use.

The securing assembly can comprise a reinforcing means. The reinforcing means can be arranged to contact at least a portion of the first part when in the securing configuration for transfer of the separation force from the first part to the securing assembly in use. Thus, the reinforcing means can reinforce the first part of the connector by reacting out the separation force from the first part allowing the force to be borne by the securing assembly in use.

The reinforcing means can be arranged to contact the first part of the connector in the region of the at least one connection between the first and second parts in the securing configuration. Preferably, the reinforcing means are arranged to abut the at least one connection in the securing configuration.

The securing assembly can further comprise a support. The support can be shaped to support the first part proximate the second part prior to actuation of the securing assembly into the securing configuration. The support can be arranged to correctly align the first part with respect to the second part.

Optionally, the support can be shaped such that when the first part is supported thereon, the reinforcing means is positioned adjacent the first part in the region of the at least one connection. Preferably the support is shaped such that when the first part is supported thereon, the reinforcing means abut the at least one connection.

Preferably, the securing assembly has an actuator that is actuable to move the securing assembly between the non-securing configuration and the securing configuration in which a secure connection is effected between the first and second parts. The actuator can be actuable by a remotely operable vehicle.

The securing assembly and the second part can be mounted on a host structure.

The host structure can be substantially static and can be a permanent or semi-permanent structure, such as those provided on a subsea installation.

The first part can be configured for remote engagement with the second part. The first part can have a handle by which the remotely actuable transporter can support the first part.

The remotely actuable transporter can be a remotely operable vehicle or a diver.

The first part can be manufactured from a buoyant material. The first part can be manufactured entirely from buoyant material. The first part can be manufactured from a buoyant material having a high strength-to-weight ratio. The first part can be manufactured from a foam, such as a syntactic foam.

The first part can be formed by casting. The first part can be formed such that the line(s) carried by the first part is/are accommodated within a body portion of the first part.

The first part can be a stab plate. The first part can be lifted and manipulated by a subsea diver.

The first part and associated connection can weigh less than 50 kg in water. The first part can weigh less than 30 kg or more preferably 20 kg in water. The first can most advantageously weigh less than 15 kg in water.

The connector can also comprise a latching member arranged to fasten the securing member in the securing configuration. The latching member can also be associated with the second part. The latching member can be mounted on the same host structure as the second part and the securing assembly. The latching member can also be actuable by a remotely operable vehicle.

The latching member can comprise a gate latch arranged to fasten the securing assembly in the securing configuration. The latching member can provide the dual function of fastening the securing assembly in the securing configuration and indicating that the securing assembly is correctly positioned relative to the first part.

According to a second aspect of the invention, there is provided a stab plate manufactured from buoyant material.

According to the second aspect of the invention, there is provided a connector having a first part, a second part and a securing assembly, wherein the first and second parts are selectively engagable and wherein the first part comprises a buoyant material and is movable by a remotely actuable transporter.

Preferably a portion of the stab plate is shaped to accommodate a reinforcing means.

All features of the first aspect of the invention are applicable to the second aspect of the invention where appropriate and wherein the stab plate of the second aspect of the invention is equivalent to the first part of the first aspect of the invention.

### BRIEF DESCRIPTION OF THE DRAWINGS

Embodiments of the invention will now be described with reference to and as shown in the accompanying drawings in which:

FIG. 2 is a perspective view of a flying part of a connector according to the invention;

FIG. 3 is a side view of the flying part of FIG. 1 supported by a securing assembly;

FIGS. 4 and 5 are part side part sectional views of a portion of the flying part and the securing assembly of FIG. 3 in a non-securing and a securing configuration respectively;

FIG. 6 is a side view of an ROV engaging the securing assembly of FIG. 3;

FIG. 7a is a rear view of the flying part with the securing assembly of FIG. 3 in the securing configuration;

FIG. 7b is a side view of the connector with the flying part and the fixed part in the securing configuration;

FIG. 8a is a part side, part sectional view of an alternative connector;

FIG. 8b is a front view of the flying part of FIG. 8a from A; and

FIG. 9 is a perspective view of a connector according to another embodiment of the invention.

### DETAILED DESCRIPTION OF THE DRAWINGS

According to a present embodiment, a connector is made up from a first part in the form of a stab plate or flying part 60, a second part in the form of a fixed part 80 and a securing assembly in the form of a clamp assembly 100.

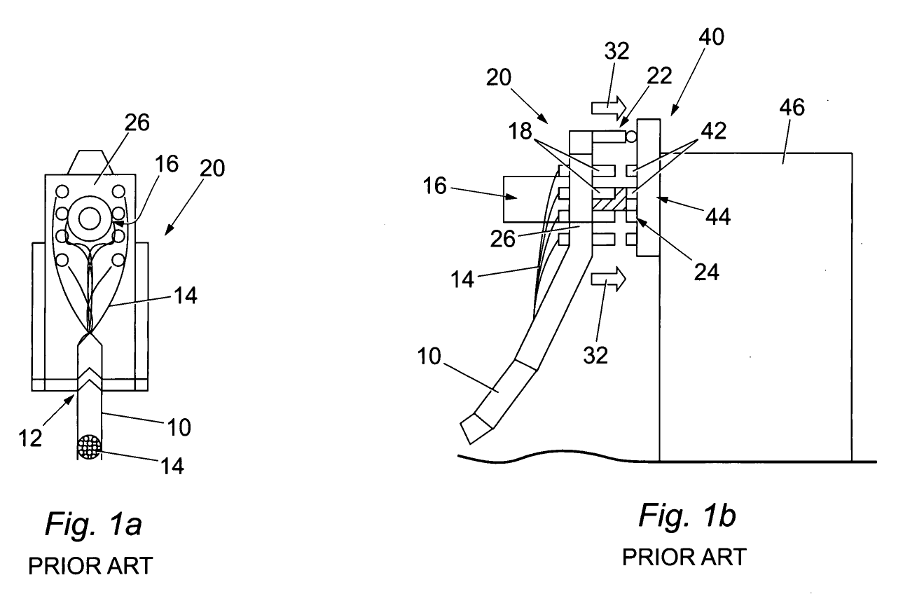

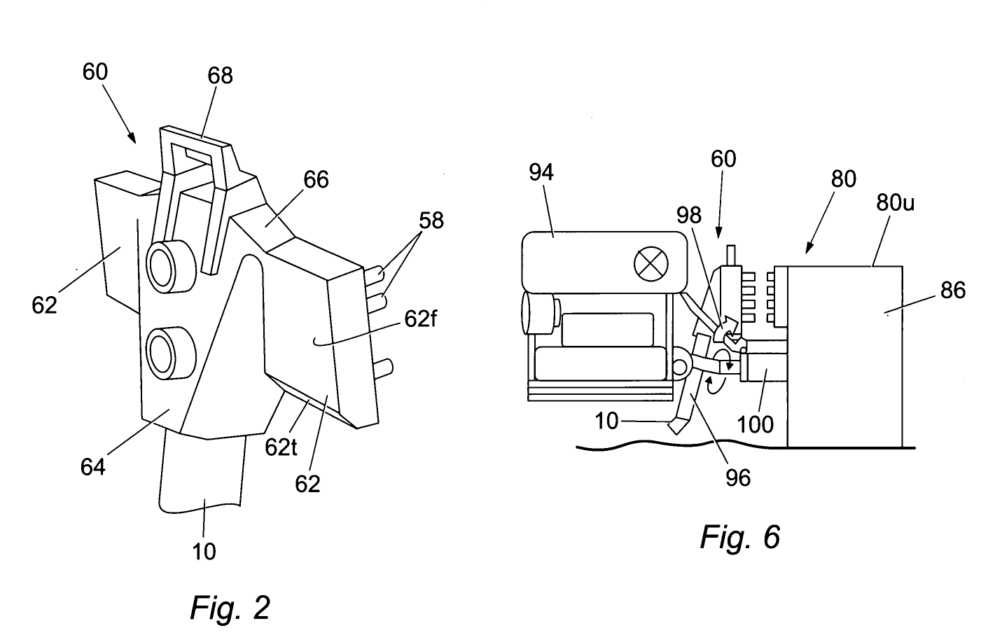

The flying part is shown generally at 60 in FIG. 2. The flying part 60 comprises a body portion 64 having two arms 62 extending outwardly therefrom. A plurality of connecting pins 58 protrude perpendicular to a front face of each arm 62. A rear face of each arm 62 is substantially planar 62f and parallel to the front face of each arm 62 with a tapered lower part 62t. The tapered portion 62t on the rear face of each arm 62 is shaped to provide alignment with the clamp assembly 100 during installation thereby removing the need for a separate alignment pin. An upper end of the body portion 64 has a handle 68 so that the flying part 60 can be supported by an ROV.

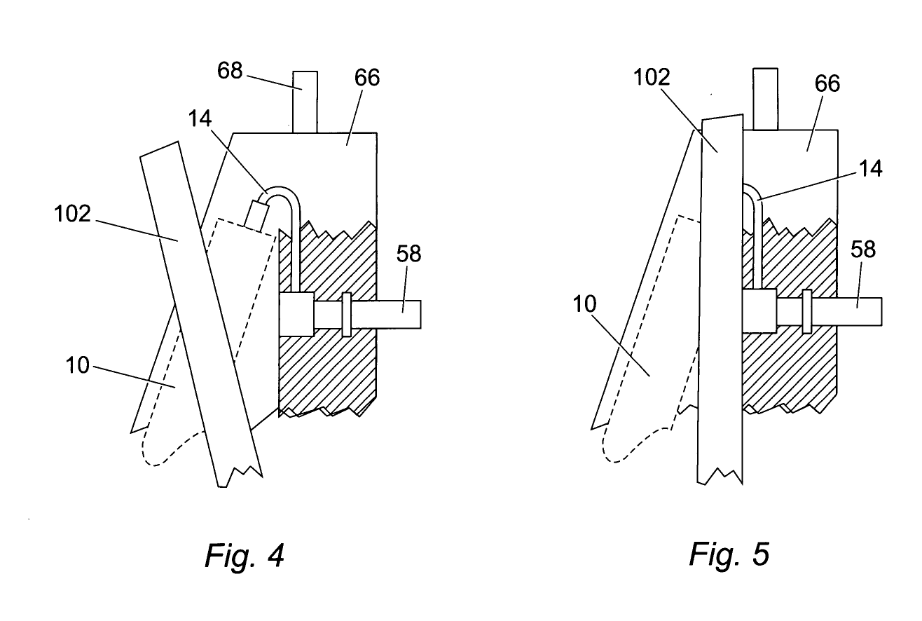

The flying part 60 is cast from buoyant syntactic foam and therefore has a high strength to weight ratio. The flying part 20 is cast around a flying lead 10 that protrudes from a lower end of the body portion 64. The flying lead 10 carries hydraulic lines 14 (FIGS. 4 and 5) that are coupled to the connecting pins 58 within the body portion 64. The flying part 60 is required only to carry the flying lead 10, the connecting pins 58 and provide the lifting handle 68 for the ROV. It is not necessarily designed to withstand the separation forces that it will be subject to in use. However, the rear face of the arms 62f is planar to facilitate the transfer of the separation forces from the connection through the clamp assembly 100.

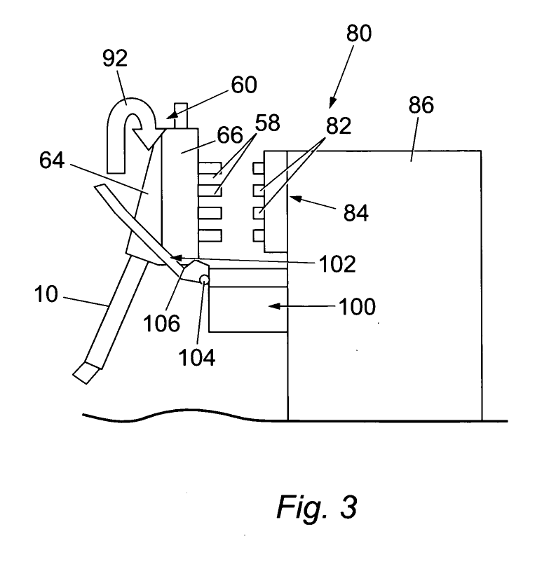

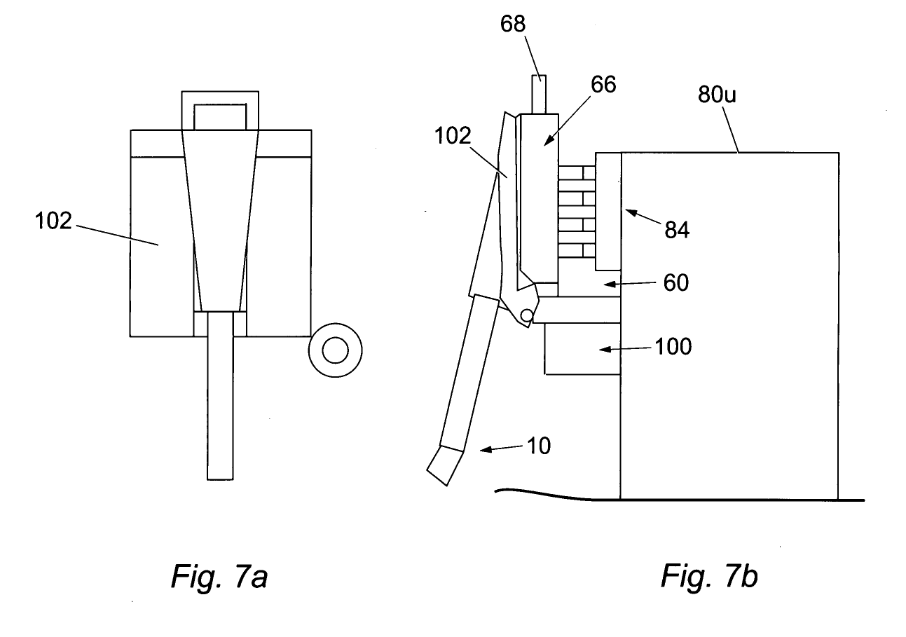

The fixed part 80 is located on a permanent or semi-permanent subsea installation 86 that requires an electric or hydraulic supply. The fixed part 80 comprises a connector plate 84 having connecting pins 82 extending outwardly therefrom. The clamp assembly 100 is mounted on the same installation 86 beneath the connector plate 84. The clamp assembly 100 comprises a forked clamp arm 102 pivotable relative to the connector plate 84 and the remainder of the clamp assembly 100 about a pivot pin 104. A lower portion of the forked clamp arm 102 is formed as a V-shaped support 106 to act as a support for a lower portion of the flying part 60. In addition to supporting the flying part 60, the clamp arm 102 is at the required height to ensure alignment of the connecting pins 58, 82 when the flying part 60 is supported thereon. The clamp assembly 100 is actuable by an ROV to move the forked clamp arm 102 between a non-securing configuration such as that shown in FIGS. 3 and 4 and a securing configuration such as that shown in FIGS. 5, 7a and 7b.

In order to effect a connection between the fixed part 80 and the flying part 60, an ROV 94 supports the flying part 60 using the lightweight handle 68 at the upper end of the body portion 64. The ROV 94 then transports the flying part 60 towards the fixed part 80. The ROV 94 lifts the flying part 60 above the clamp assembly 100 to locate the body portion 64 between the forks of the clamp arm 102 as shown by an arrow 92 in FIG. 3. The tapered face 62t of the flying part arm 62 is supported by the V-shaped support 106 of the forked clamp arm 102 to support and correctly locate the flying part 60 in a rest position adjacent the fixed part 80.

As shown in FIG. 6, the ROV 94 then engages with the actuator of the clamp assembly 100 using an ROV arm 96. The arm 96 drives the forked clamp arm 102 from the position angled relative to the structure 86 to a position parallel to the structure 86 in a direction shown by an arrow 98. The V-shaped notch 106 of the clamp arm 102 and the tapered part 62t of the flying part 60 interact to correctly align the connection pins 58 of the flying part with the connection pins 82 of the fixed part 80. The front face of the forks of the clamp arm 102 are planar and abut the rear face 62f of the arms 62 in the securing configuration. Thus, the arms 62 are immediately adjacent the connection pins 58 of the flying part 60 and are positioned to reinforce the arms 62 behind the connecting pins 58 as shown in FIG. 7a.

Although the lines 14 are in communication once the connecting pins 58, 82 are engaged, generally the connection must be secured prior to use of the lines 14 that provide communication between the first and second parts. For example, when the connection is used for hydraulic fluid communication, use of the hydraulic fluid within the lines 14 at pressure can generate separation forces that can overcome the coupling between the connecting pins 58, 82. Hence, it is usually necessary to secure the connection prior to use.

Previously, the flying part was designed to withstand the separation forces when the hydraulic couplings are pressurised using the clamp assembly 100 and therefore the flying part was necessarily made from materials with the required strength. However, the present invention reacts the separation forces out through the forked clamp arm 102 that contacts the rear face of the arm 62 when the flying part 60 and the fixed part 80 are in the securing configuration. As a result, the flying part 60 is only required to withstand the loads associated with lifting and installation and therefore different materials can be used in the manufacture of the flying part 60. Manufacture of the flying part 60 from buoyant material, such as foam represents a significant advantage, since the flying lead 10 can be moulded within the body of the flying part 60 to provide a degree of protection for the hydraulic lines 14.

Optionally, a gate latch (not shown) is pivotally attached to an upper surface of the fixed part 80. The gate latch comprises two substantially planar coupled bars having a lip at their leading edge. Once the connection between the connector pins 58, 82 has been made up and following engagement of the forked clamp arm 102 with the flying part 60, the ROV 94 contacts the gate latch and pivots the gate latch into position over the flying part 60 and the clamp arm 102, and the lip of each bar is arranged in position over a rear face of the clamp arm 102 such that the lip abuts the rear face of each arm 62, thereby substantially restricting movement of the flying part 60 away from the fixed part 80. Thus, the gate latch provides additional redundancy, making a second point of engagement and fastening the clamp assembly to the fixed part 80. The gate latch also has a dual function as an indicator to gauge whether the flying part 60 is adequately secured to the fixed part 80. This is an inherent function of the gate latch since the distance from the pivot point of the latch to the lip of the latch is accurately calculated to account for the expected distance of the forked clamp arm 102 from the fixed part 80 when a secure connection is made therebetween.

There are several key advantages of the present invention. Separation forces generated when hydraulic pressure is applied to the connector are reacted out of the flying part 60 through the forked clamp arm 102 and therefore it is no longer necessary to design the flying part 60 to withstand these separation forces. Furthermore, the clamp assembly 100 is mounted on the fixed part 80 and therefore no longer has to be accommodated by the flying part 60 thereby significantly reducing the functionality and consequently the weight of the flying part 60. The flying part 60 has a lightweight handle 68 allowing it to be carried by the ROV, in preference to the heavier conventional drive means 16.

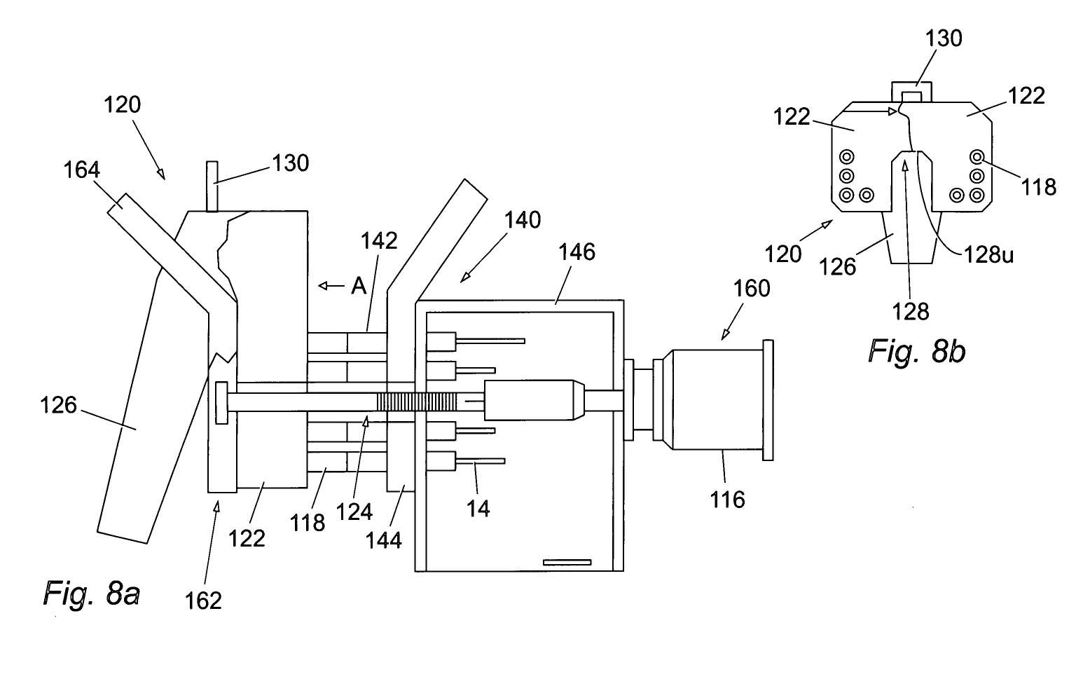

An alternative embodiment is shown in FIGS. 8a and 8b. A first part or flying part is shown generally at 120 and a second part or fixed part is shown generally at 140.

An upper part of the body portion 126 has an ROV handle 130 by which the ROV can carry the flying part 120. The flying part 120 comprises a body portion 126 manufactured from foam and the body portion 126 is cast around a flying lead as previously described. Arms 122 having a planar front face extend outwardly from the body portion 126 and carry a plurality of connection pins 118. The arms 122 are provided with a centrally disposed notch 128 allowing the flying part 120 to be supported on an upper surface 128u of the notch.

The fixed part 140 comprises a connector plate 144 mounted on a host structure 146. The plate 14 has connection pins 142 extending perpendicular thereto and outwardly with respect to the host structure 146. Each of the connection pins 118, 142 is coupled to a respective line 14.

A securing assembly is shown generally at 160 and comprises a drive bucket 116 mounted on an opposing side of the host structure 146 from the connector plate 144. The drive bucket 116 is drivably connected to a locking screw 124 that passes through a centrally disposed threaded opening (not shown) within the plate 144 of the fixed part 140. One end of the locking screw 124 is fixed to a reinforcing plate 162 that is positioned parallel to the plate 144 of the fixed part 140.

In order to effect the connection between the flying part 120 and the fixed part 140, an ROV carries the flying part 120 using the handle 130 proximate the host structure 146. The ROV aligns the flying part 120 with the reinforcing plate 162 profile and lowers the flying part 120 into position such that the profile of the flying part 120 is supported by the matching profile of the reinforcing plate 162 and a rear face of the arms 122 abuts a front face of the reinforcing plate 162. The ROV then engages the drive bucket 116 of the securing assembly 160 to rotate the locking screw 124 within the threaded opening of the plate 144 to thus drive the reinforcing plate 162 towards the host structure 146.

All the advantages described in connection with the previous embodiment are also applicable to the present embodiment. Additionally, the present embodiment has the advantage that the connection pins 118 of the flying part 120 abut the reinforcing plate 162 when the flying part 120 is supported on the retractable locking screw 124 and prior to actuation of the drive bucket 116 to move the securing assembly 160 into the securing configuration. This allows a connection to be effected in the situation when the connecting pins 118, 142 are connected to hydraulic lines that are live and therefore require immediate reinforcement at the moment the connection is made.

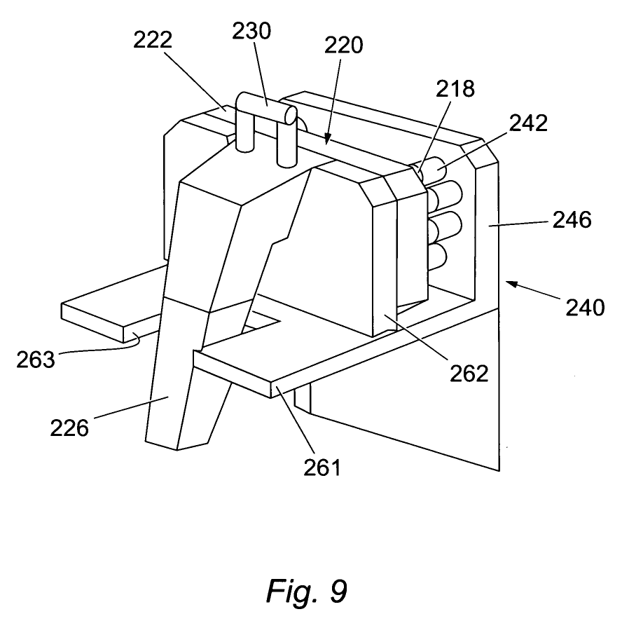

FIG. 9 shows an alternative preferred embodiment of the invention. Like components of FIG. 9 have been given the same reference numerals as in FIGS. 8a and 8b, with the prefix “2” rather than “1”.

The flying part 220 of FIG. 9 carries twenty hydraulic connections weighing approximately 1.4 kg each and three twelve-pin electrical connector pins weighing approximately 1.2 kg each. The flying part 220 is manufactured from syntactic foam cast around the hydraulic and electrical lines and also incorporates a lifting handle weighing around 6 kg. In total 40 litres of foam is required for the casting and this provides approximately 14 kg buoyancy. As a result, the effective weight of the flying part 220 in water is 23 kg.

The host structure 246 has a platform 261 protruding perpendicular therefrom. The platform 261 has a rectilinear cutaway 263 to accommodate the body portion 226 of the flying part 220. The platform 261 is also provided with an upstanding reinforcing plate 262 that is parallel to and slidable relative to the host structure 246.

The connection between the pins 218 of the flying part and the pins 242 of the host structure 240 is achieved in a similar manner to that previously described. An ROV flies the flying part 220 such that the rear face of the arms of the flying part 220 about the reinforcing plate 262. The reinforcing plate 262 is then actuated to move towards the host structure 246 and secure the connection between the pins 218, 242.

Therefore, the flying part 220 is moved axially to effect the connection between the pins 218, 242. The flying part 220 is held in a vice-like manner between the reinforcing plate 262 and the host structure.

Separation forces resulting from the hydraulic pressure can be reacted out via the reinforcing plate 262 to the host structure 246. This embodiment achieves an electro hydraulic connection by providing a stab plate with low weight.

According to any embodiments of the invention, the flying parts 60, 120, 220 can be lifted, maneuvered and connected by a diver in preference to or in conjunction with an ROV. Previously the stab plates could only be manipulated by ROVs since they were too heavy to be safely handled by divers.

Modifications and improvements can be made without departing from the scope of the invention. For example, the connector and method of the invention can also be used to effect surface connections.

1. A connector having a first part, a second part and a securing assembly associated with the second part,
wherein the first and second parts are selectively engagable and wherein the first part is movable by a remotely actuable transporter; and
wherein the securing assembly is provided for securing the connection between the first and second parts.

2. A connector according to claim 1, wherein the connector is a subsea connector.

3. A connector according to claim 1, wherein the first and second parts are each provided with at least one complementary connection in the form of a plug and a socket arrangement.

4. A connector according to claim 3, wherein each of the first and second parts carry at least one line and the complementary connections are arranged to provide communication between the lines when the first part is in engagement with the second part.

5. A connector according to claim 4, wherein the at least one line comprises a line selected from the group consisting of: hydraulic lines; electric cables; and a bundle of such lines/cables.

6. A connector according to claim 1, wherein the securing assembly is actuable between a non-securing configuration and a securing configuration in which a secure connection is effected between the first and second parts.

7. A connector according to claim 6, wherein the securing assembly comprises a reinforcing means arranged to contact at least a portion of the first part when in the securing configuration for transfer of the separation force from the first part to the securing assembly in use.

8. A connector according to claim 7, wherein the reinforcing means is arranged to abut the at least one connection in the securing configuration.

9. A connector according to claim 6, wherein the securing assembly further comprises a support shaped to support the first part proximate the second part prior to actuation of the securing assembly into the securing configuration.

10. A connector according to claim 9, wherein the support is arranged to correctly align the first part with respect to the second part and shaped such that when the first part is supported thereon, the reinforcing means abut the at least one connection.

11. A connector according to claim 6, wherein the securing assembly has an actuator that is actuable by a remotely operable vehicle to move the securing assembly between the non-securing configuration and the securing configuration.

12. A connector according to claim 1, wherein the securing assembly and the second part are mounted on a host structure forming at least a part of a subsea installation.

13. A connector according to claim 1, wherein the first part is configured for remote engagement with the second part and wherein the first part has a handle for cooperation with the remotely actuable transporter.

14. A connector according to claim 1, wherein the first part is manufactured from a buoyant material.

15. A connector according to claim 1, wherein the first part is manufactured from a material with a high strength-to-weight ratio.

16. A connector according to claim 1, wherein the first part is manufactured from a syntactic foam.

17. A connector according to claim 1, wherein the first part is formed by casting.

18. A connector according to claim 1, wherein the first part is a stab plate.

19. A connector according to claim 6, comprising a latching member arranged to fasten the securing member in the securing configuration and wherein the latching member is mounted on a host structure, on which the second part and the securing assembly are also mounted.

20. A connector according to claim 19, wherein the latching member is actuable by a remotely operable vehicle and comprises a gate latch arranged to fasten the securing assembly in the securing configuration.

21. A connector according to claim 19, wherein the latching member provides the dual function of fastening the securing assembly in the securing configuration and indicating that the securing assembly is correctly positioned relative to the first part.

22. A method for making a connection including the steps of:
providing a connector having a first part and a second part;
providing a securing assembly associated with the second part;
engaging the first and second parts to make a connection therebetween; and
engaging the securing assembly with the first part to secure the first and second parts.

23. A stab plate adapted for use subsea and manufactured from buoyant material.

24. A stab plate according to claim 23, wherein the weight of the stab plate in water is less than 25 kilograms.

25. A connector having a first part, a second part and a securing assembly, wherein the first and second parts are selectively engagable and wherein the first part comprises a buoyant material and is movable by a remotely actuable transporter.
